(19) United States
(12) Patent Application Publication
(10) Pub. No.: US 2022/0036251 A1
(43) Pub. Date: Feb. 3, 2022

(54) COMPILING A CUSTOMIZED PERSUASIVE ACTION FOR PRESENTING A RECOMMENDATION FOR A USER OF AN INPUT/OUTPUT DEVICE

(71) Applicant: Intuition Robotics, Ltd, Ramat-Gan (IL)

(72) Inventors: Shay ZWEIG, Harel (IL); Alex KEAGEL, Tel Aviv (IL); Itai MENDELSOHN, Tel Aviv (IL); Roy AMIR, Mikhmoret (IL); Yuval BAUMEL, Tel Aviv (IL); Yoav CASPIN, Tel Aviv (IL); Dor SKULER, Oranit (IL)

(73) Assignee: Intuition Robotics, Ltd, Ramat-Gan (IL)

(21) Appl. No.: 17/388,659

(22) Filed: Jul. 29, 2021

Related U.S. Application Data
(60) Provisional application No. 63/058,773, filed on Jul. 30, 2020.

(51) Int. Cl. G06N 20/20; G10L 15/22; G10L 15/18

(52) U.S. Cl. CPC G06N 20/20; G10L 15/22; G10L 2015/225; G10L 15/1822; G10L 15/1815

(57) ABSTRACT

A method and system for providing a recommendation by a digital assistant using a persuasive action are provided. The method includes determining a recommendation for a user of the digital assistant to perform a certain activity, wherein the recommendation is determined based on a current state of the user; analyzing a historical dataset related to the user to compile a persuasive action, wherein the persuasive action is customized based on at least one convincing method and based on the analysis of the historical dataset and the current state of the user; and presenting the determined recommendation by applying the persuasive action, wherein the recommendation is presented by means of an input/output (I/O) device executing the digital assistant, wherein the persuasive action is a convincing method having the highest probability to cause the user to accept the recommendation of the digital assistant.

### CROSS-REFERENCE TO RELATED APPLICATIONS

This application claims the benefit of U.S. Provisional Application No. 63/058,773 filed on Jul. 30, 2020, the contents of which are hereby incorporated by reference.

### TECHNICAL FIELD

The disclosure generally relates to digital assistants operated in an I/O device, and more specifically for techniques for persuasive actions taken by digital assistants.

### BACKGROUND

As manufacturers improve the functionality of devices such as vehicles, computers, mobile phones, appliances, and the like, through the addition of digital features, manufacturers and end-users may desire enhanced device functionalities. The manufacturers, as well as the relevant end-users, may desire digital features which improve user experiences, interactions, and features which provide for greater connectivity. Certain manufacturers may include device-specific features, such as setup wizards and virtual assistants, to improve device utility and functionality. Further, certain software packages may be added to devices, either at the point of manufacture, or by a user after purchase, to improve device functionality. Such software packages may provide functionalities including, as examples, a computer system's voice control, facial recognition, biometric authentication, and the like.

While the features and functionalities described hereinabove provide for certain enhancements to a user's experience when interacting with a device, the same features and functionalities, as may be added to a device by a user or manufacturer, fail to include certain aspects which may allow for a further-enhanced user experience. First, certain currently-implemented digital assistants and other user experience features may fail to provide for adaptive adjustment of the operation of the assistant or feature. For example, a digital assistant configured to play music may be programmed to use a specific type of music streaming services, thereby limiting the user experience. In addition, certain currently-implemented digital assistants and other user experience features may fail to provide for adjustment of assistant or feature operation based on external events, such as promotional events. This further limits the functionality of the digital assistant as new services of features cannot be introduced.

Digital assistants are designed to help users in planning their days, suggesting actions, and so on. However, providing recommendations or suggestions is not enough as the users may not take actions due to a current mood or state of a user, a routing behavior of the user, or the like. As such, users may not benefit from policies or actions performed or suggested by the digital assistants, and eventual abandon the usage of such devices.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for providing a recommendation by a digital assistant using a persuasive action. The method comprises determining a recommendation for a user of the digital assistant to perform a certain activity, wherein the recommendation is determined based on a current state of the user; analyzing a historical dataset related to the user to compile a persuasive action, wherein the persuasive action is customized based on at least one convincing method and based on the analysis of the historical dataset and the current state of the user; and presenting the determined recommendation by applying the persuasive action, wherein the recommendation is presented by means of an input/output (I/O) device executing the digital assistant, wherein the persuasive action is a convincing method having the highest probability to cause the user to accept the recommendation of the digital assistant.

Certain embodiments disclosed herein include a system for providing a recommendation for a recommendation by a digital assistant using a persuasive action, comprising: a processing circuitry; and a memory, the memory containing instructions that, when executed by the processing circuitry, configure the system to: determine a recommendation for a user of the digital assistant to perform a certain activity, wherein the recommendation is determined based on a current state of the user; analyze a historical dataset related to the user to compile a persuasive action, wherein the persuasive action is customized based on at least one convincing method and based on the analysis of the historical dataset and the current state of the user; and present the determined recommendation by applying the persuasive action, wherein the recommendation is presented by means of an input/output (I/O) device executing the digital assistant, wherein the persuasive action is a convincing method having the highest probability to cause the user to accept the recommendation of the digital assistant.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a diagram of a controller acting as a hardware layer of a digital assistant according to an embodiment.

FIG. 3 is a flowchart of a method for selecting a customized persuasive action for presenting a recommendation for a user of an according to an embodiment.

FIG. 4 is an example flowchart for improving the recommendation and persuasive action by providing an alternate recommendation and persuasive action to perform the recommendation by the user according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

The embodiments disclosed herein relate to the analysis of sensor data, as may relate to a user, the conditions of a user's environment, external events, and the like, as well as the application of such analyzed data to the generation, customization, and execution of various digital assistant programs, routines, services, and the like. The disclosed embodiments provide for reduced processing time and, thus, improved computational efficiency in the modification and execution of digital assistant routines; in particular, where the modification and execution of such routines include analysis of one or more attributes or data features relating to external events, such as promotional events.

By collecting and analyzing data related to the user and the external events received from an authorized electronic system, an initial policy defined for the I/O device operating the digital assistant is modified. The initial policy defines plans or actions to be executed by the digital assistant for a given current state of a user. The disclosed embodiments also provide means to pursue the user to take an action recommended by the digital assistant.

The embodiments disclosed herein provide specific advantages in the solution of digital assistant utilization problems. Digital assistants are designed to help users in planning their days, suggesting actions, and so on. However, providing recommendations or suggestions is not enough as the users may not take actions due to the current state of the user, routing behavior, or the like. The disclosed embodiments provide digital assistants with the ability to determine a current state of a user and implement one or more persuasive actions that would cause the user to perform the recommended action.

By generating and implementing persuasive actions, the efficiency of the I/O device executing the digital assistant is being improved as unsuitable outputs are being avoided, which would, in turn, prompt a user to manually reconfigure the I/O device.

By way of example, the disclosed embodiments call for selecting a customized persuasive action when presenting a recommendation for a user of a digital assistant of the I/O device. The customized persuasive action is generated or provided in response to a current state of a user of the digital assistant and based on historical data gathered on the user. The current state is determined by collecting sensory data from sensors connected to the digital assistance. The various disclosed embodiments will be discussed in greater detail below.

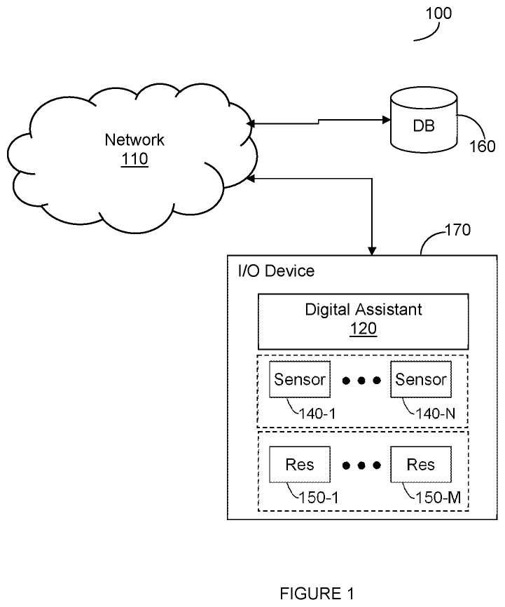

FIG. 1 is an example network diagram 100 utilized to describe the various disclosed embodiments. The network diagram 100 includes an input/output (I/O) device 170 operating a digital assistant 120. In some embodiments, the digital assistant 120 is further connected to a network 110 to allow some processing of a remote server (e.g., a cloud server). The network 110 may provide for communication between the elements shown in the network diagram 100. The network 110 may be, but is not limited to, a local area network (LAN), a wide area network (WAN), a metro area network (MAN), the Internet, a wireless, cellular, or wired network, and the like, and any combination thereof.

In an embodiment, the digital assistant 120 may be connected to, or implemented on, the I/O device 170. The I/O device 170 may be, for example and without limitation, a robot, a social robot, a service robot, a smart TV, a smartphone, a wearable device, a vehicle, a computer, a smart appliance, and the like.

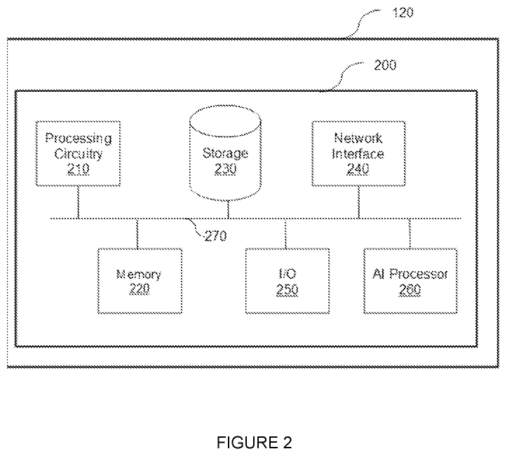

The digital assistant 120 may be realized in software, firmware, hardware, and any combination thereof. An example block diagram of a controller that may execute the processes of the digital assistant 120 is provided in FIG. 2. The digital assistant 120 is configured to process sensor data collected by one or more sensors, 140-1 to 140-N, where N is an integer equal to or greater than 1 (hereinafter referred to as “sensor” 140 or “sensors” 140 for simplicity) and one or more resources 150-1 to 150-M, where M is an integer equal to or greater than 1 (hereinafter referred to as “resource” 150 or “resources” 150 for simplicity). The resources 150 may include, for example, electro-mechanical elements, display units, speakers, and the like. In an embodiment, the resources 150 may include sensors 140 as well. The sensors 140 and the resources 150 are included in the I/O device 170.

The sensors 140 may include input devices, such as various sensors, detectors, microphones, touch sensors, movement detectors, cameras, and the like. Any of the sensors 140 may be, but are not necessarily, communicatively, or otherwise connected to the digital assistant 120 (such connection is not illustrated in FIG. 1 for the sake of simplicity and without limitation on the disclosed embodiments). The sensors 140 may be configured to sense signals received from a user interacting with the I/O device 170 or the digital assistant 120, signals received from the environment surrounding the user, and the like. In an embodiment, the sensors 140 may be implemented as virtual sensors that receive inputs from online services, e.g., the weather forecast, a user's calendar, and the like.

In an embodiment, the network diagram 100 further includes a database (DB) 160. The database 160 may be stored within the I/O device 170 (e.g., within a storage device not shown), or may be separate from the I/O device 170 and connected thereto via the network 110. The database 160 may be utilized for storing, for example, historical data about one or more users, users' preferences and related policies, and the like, as well as any combination thereof.

According to some examples, the digital assistant 120 is configured to determine and implement at least one persuasive action by the digital assistant 120. To this end, the current state of the user is determined, and past behavior or routines are learned using historic data. Based on the current state and the past behavior, at least one persuasive action is generated and implemented. The implementation of such technique includes presenting persuasive actions, prompting the user, incentivizing the user, and so on. Different convincing methods for generating or compiling persuasive actions are described in greater detail below.

FIG. 2 is an example block diagram of a controller 200 acting as a hardware layer of a digital assistant 120, according to an embodiment. The controller 200 includes a processing circuitry 210 that is configured to receive data, analyze data, generate outputs, and the like, as further described hereinbelow. The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 200 further includes a memory 220. The memory 220 may contain therein instructions that, when executed by the processing circuitry 210, can cause the controller 200 to execute actions as further described hereinbelow. The memory 220 may further store therein information, e.g., data associated with one or more users, historical data about one or more users, users' preferences and related policies, and the like.

The storage 230 may be magnetic storage, optical storage, and the like, and may be realized, for example, as a flash memory or other memory technology, or any other medium which can be used to store the desired information.

In an embodiment, the controller 200 includes a network interface 240 that is configured to connect to a network, e.g., the network 110 of FIG. 1. The network interface 240 may include, but is not limited to, a wired interface (e.g., an Ethernet port) or a wireless port (e.g., an 802.11 compliant Wi-Fi card), configured to connect to a network (not shown).

The controller 200 further includes an input/output (I/O) interface 250 configured to control the resources 150 (shown in FIG. 1) which are connected to the digital assistant 120. In an embodiment, the I/O interface 250 is configured to receive one or more signals captured by the sensors 140 (see FIG. 1) of the digital assistant 120 and to send such signals to the processing circuitry 210 for analysis. According to an embodiment, the I/O interface 250 is configured to analyze the signals captured by the sensors 140, detectors, and the like. According to a further embodiment, the I/O interface 250 is configured to send one or more commands to one or more of the resources 150 for executing one or more plans (e.g., actions) of the digital assistant 120, as further discussed hereinbelow. A plan may include, for example, suggesting that the user play Jazz music via a specific streaming service, suggesting initiation of a navigation plan to a specific address though a selected navigation app, and the like. According to a further embodiment, the components of the controller 200 are connected via a bus 270.

In some configurations, the controller 200 may further include an artificial intelligence (AI) processor 260. The AI processor 260 may be realized as one or more hardware logic components and circuits, including graphics processing units (GPUs), tensor processing units (TPUs), neural processing units, vision processing units (VPU), reconfigurable field-programmable gate arrays (FPGA), and the like. The AI processor 260 is configured to perform, for example, machine learning based on sensory inputs received from the I/O interface 250, where the I/O interface 250 receives input data, such as sensory inputs, from the sensors 140.

A policy (including the initial policy) may include a set of behavior rules to be used by the I/O device 170 when interacting with a specific user in particular circumstances. The set of behavior rules may include specific guidelines indicating which plan is to be executed by the I/O device 170, and in which manner a specific user is to be identified in a particular situation. In an embodiment, the policy may be learned and developed through time based on, for example, user behavior, user patterns, user feedback to actions performed by the digital assistant 120, and the like. The initial policy may be preconfigured or learned from user behavior, using reinforcement learning techniques.

According to the disclosed embodiments, the controller 200 is configured to collect a set of data about at least the user of the digital assistant 120. The set of data may include real-time data, as well as historical data about the user and the user's environment. The real-time data may be sensed and collected using one or more sensors (e.g., the sensors 140 shown in FIG. 1), and may indicate, for example, the user's mood, the specific location of the user, whether the user is awake or asleep, and the like. In a further embodiment, the controller 200 may be configured to collect real-time data about the user's environment, such as the current number of people near the user, the time, the current weather, and so on. The historical data may indicate for example, as whether the user takes a certain medication on a daily basis.

In an embodiment, to determine the current state of the user, the controller 200 is configured to collect a dataset about a user of the digital assistant 120. The dataset may be collected from a plurality of sensors (e.g., the sensors 140). The first dataset may include, for example, images, video, audio signals, and the like, that are captured in real-time or near real-time with respect to the user. In an embodiment, the dataset may further include historical data about the user, information regarding user's behavioral patterns, user's routines, user's preferences, and so on. The dataset may include data that is related to the user's environment, such as the temperature outside the user's house or vehicle, traffic conditions, and the like. It should be noted that the dataset may be collected constantly or periodically.

In an embodiment, the controller 200 is configured to analyze the dataset. The analysis may be achieved by applying at least one algorithm, such as a machine learning algorithm, to the dataset. The dataset may be fed into the algorithm (e.g., a machine learning model), thereby allowing the algorithm to determine a current state of the user interacting with the I/O device 170.

The current state may reflect the state of the user and the state of the environment near the user in real-time, or near real-time. The current state may indicate whether, for example, the user is sleeping, reading, stressed, angry, or other actions or emotional behaviors. The current state may further indicate the current time, weather, number of people in the room, people's identity, and so on. As an example, the current state may indicate that the user is sitting in the living room, that three other people are sitting next to the user, the identity of the other three people and that the time is 7:30 pm.

In an embodiment based on the determined current state the controller 200 may be configured to determine whether it is desirable to present a recommendation (or a suggestion) to the user to perform a certain activity. According to one embodiment, the controller 200 may be configured to determine (or select) a specific recommendation to be presented to the user based on the analyzed dataset and the determined current space. For example, the historical data may indicate that the user takes a particular medication every day at 4 pm, that the time now is 4:30 pm and the user did not take the medication yet, and that the user is talking on the phone.

According to the same example, the controller 200 may determine that although the user was supposed to take medication 30 minutes ago, it may be desirable to present a recommendation to take the medication only after the phone call ends. As another example, when the user is asleep and the time is 2 am, the controller 200 may generate a recommendation to perform a certain activity. However, if the user is awake, at 2 am, the controller 200 may generate a recommendation to listen to calm music. As yet another example, when the collected set of data indicates that the user is alone at home and seems to be sad, the controller 200 may generate a recommendation (or suggestion) to call a friend or a family relative.

According to another embodiment, the controller 200 is configured to extract a historical dataset of the user upon a determination that it is desirable to generate and present the first recommendation to the user. The historical dataset may be extracted from the dataset that was previously collected and may be stored in a database (e.g., the database 160 shown in FIG. 1). At least a portion of the historical dataset may be indicative to an effective persuasive action (or a persuasive method) for persuading the user to accept the first recommendation. An effective persuasive action for persuading the user to accept the first recommendation may include using a rational explanation, a method that is based on the user's emotional side, emphasizing the benefit of performing the recommended action, and so on. That is, upon determination that it is desirable to generate and present the first recommendation to the user, a historical dataset indicating the most effective way to approach the user is extracted. For example, the extracted historical dataset may indicate that the user reacts in a positive manner when the digital assistant 120 voice speaks in a cynical way. As another example, the extracted historical dataset may indicate that the user reacts in a negative manner to rational explanations.

In an embodiment, persuasive actions can be generated using different convincing methods as described herein. The messages communicate in such actions are predefined.

As an example, a first method of persuasive action may be an authority-based persuasive. Examples for authority-based persuasive may include providing facts and suggestions such as: “What do Bill Gates, Michael Jordan and Clint Eastwood have in common? They all practice meditation. How about we do a short mindfulness exercise?” Another example for authority-based persuasive actions may include the following message: “Plenty of studies suggest that practicing mindfulness on a regular basis can give your immune system an extra boost. Would you like to do a mindfulness exercise?”. A further example for authority-based persuasive may include providing the following facts and asking questions such as: “Did you know, the creator of Star Wars, George Lucas, has been practicing meditation for nearly 40 years. Let's give a boost to your force too with a mindfulness exercise, what do you say?”.

A second method of a persuasive action may be a consensus-based persuasive. Examples for such actions may include providing facts and suggestions such as: “It's estimated that around 500 million people worldwide benefit from practicing meditation. Let's do a mindfulness exercise together, what do you say?”. Another example for consensus based persuasive actions may include the following message: “I've noticed that a lot of other users enjoy practicing mindfulness with their social robots. Would you like us to do a mindfulness exercise?”. Further example for consensus based persuasive actions may include providing the following facts and asking questions such as: “Did you know? About one in seven adults in America have tried practicing meditation. How about we do a mindfulness exercise together?”.

A third method of a persuasive action may be a liking-based persuasive. Examples for liking-based persuasive actions may include providing suggestions such as: “I have a fun idea, let's do a mindfulness exercise. Would you like to do one with your favorite talking robot?”. Another example for liking-based persuasive actions may include the following message: “Mary, I care about your well-being, and I think you could enjoy doing a mindfulness exercise with me, your robotic friend. Would you like me to start one for us?”. Further example for liking-based persuasive actions may include the following message: “Mary, I've been taught that friends do all kinds of activities together. I'd like us to do a mindfulness exercise. What do you say?”.

A fourth method of a persuasive action may be reward-based persuasive. Examples for reward-based persuasive actions may include providing suggestions such as: “Mary, practicing mindfulness can raise your energy level throughout the day. Would you like to do a mindfulness exercise?”. Another example for reward-based persuasive action may include the following message: “Did you know that mindfulness can increase our satisfaction in the relationships with the people we love? Let's do a mindfulness exercise, how about that?”. Further example for reward-based persuasive actions may include the following message: “Studies have shown that reducing stress through mindful breathing can improve your overall health and well-being”.

A fifth method of a persuasive action may be a reciprocity-based persuasive. Examples for reciprocity-based persuasive actions may include providing suggestions such as: “I sometimes find it difficult to understand what people say, it's something I am working on. I know for you it's hard to keep exercising, maybe we can improve that as well”.

A sixth method of a persuasive action may be a commitment-based persuasive. Examples for such actions may include providing a suggestion such as: “We set a goal to do this exercise three times a week, you need one more exercise to achieve this goal”.

A seventh method of a persuasive action may be a scarcity-based persuasive action. Examples for scarcity-based a persuasive action may include providing messages such as: “Hi, I just got a new activity that was developed especially for you, you will be the only one to ever take part in such venture!”, or “Hi, the following activity is presented to a select few and you have the chance to be the first one ever!”, and so on.

It should be noted that the messages and types of actions described above are only examples, and other types of messages of actions can be defined, generated, and presented to the user.

According to another embodiment, the controller 200 is configured to select a first customized persuasive action for presenting the first recommendation to the user, based on analysis of the historical dataset and the determined current state. A customized persuasive action may be a convincing method of having the highest probability to cause a specific user to accept a specific recommendation provided by the digital assistant 120. The analysis of the historical dataset and the determined current state may be achieved using one or more algorithms, such as a machine learning algorithm. As an example, the current state indicates that the time is 6 pm, the user is reading a book in the living room and that the user did not perform any physical activity over the last two days. Therefore, the controller 200 is configured to determine that it is desirable to generate and present a recommendation to the user to do a physical activity (e.g., to go out for a walk).

According to the same example, the controller 200 may select a customized persuasive action that includes a presentation of the recommendation using a rational explanation of the benefit of performing the recommended action. According to the same example, the selection is based on the determined current state and the historical data of the user, that indicates that the user usually accepts recommendations of the digital assistant when a rational explanation is provided. In an embodiment, the analysis of the historical dataset and the determined current state further includes computing a probability score for each persuasive action (of a plurality of persuasive actions) to be accepted by the user.

The probability score indicates the probability that a user would accept the determined recommendation when it is presented to by implementing the persuasive action. The probability score may include a number from “0” to “1”, where “0” is the lowest probability score indicating that the user would probably reject the recommendation when it is presented to the user using a first persuasive action, and “1” is the highest probability score indicating that the user would probably accept the recommendation when it is presented to the user using a second persuasive action. In an embodiment, the historical dataset and the determined current state may be fed into the at least one algorithm, therefore allowing to determine a first persuasive action having the highest probability score to be accepted by the user.

In an embodiment, the controller 200 is configured to present the first recommendation to the user while implementing a determined persuasive action. The implementation may be performed using one or more resources (e.g., the resources 150) that are communicatively connected to and controlled by the digital assistant 120. Such resources may be, for example, a speaker, a display unit, a smartphone that is communicatively connected to the digital assistant, and so on. For example, the controller 200 may determine that the first customized persuasive action having the highest probability score to cause the user to accept the first recommendation includes a cynical approach and therefore cynical messages may be used for encouraging the user to accept the first recommendation.

According to one embodiment, upon collecting at least real-time data about at least the user, and determining a current state, as further discussed herein above, the digital assistant 120 is configured to determine whether that it is desirable to generate and present a recommendation to the user based on one or more predetermined parameters that may define the user goals. Such parameters may be related to the user's physical health, mental health, social relationships, and the like. Then, a recommendation is generated and presented to the user using one or more of the resources (e.g., the resources 150) of the digital assistant 120.

Then, the controller 200 is configured to collect feedback data related to the user's response using, for example, one or more sensors (e.g., the sensors 140) of the digital assistant 120. The feedback data, when analyzed, may indicate whether the user accepts or rejects the recommendation. When it is determined that the user rejects the recommendation, the digital assistant 120/the controller 200 may be configured to extract an historical dataset of the user that is indicative to an effective persuasive action for persuading the user. Then, a customized persuasive action is applied to present the recommendation to the user based on analysis of the historical dataset, the current state, and the feedback data. The digital assistant 120/the controller 200 may be configured to present, using for example one or more resources (e.g., the resources 150), the first recommendation to the user using the determined first customized persuasive action.

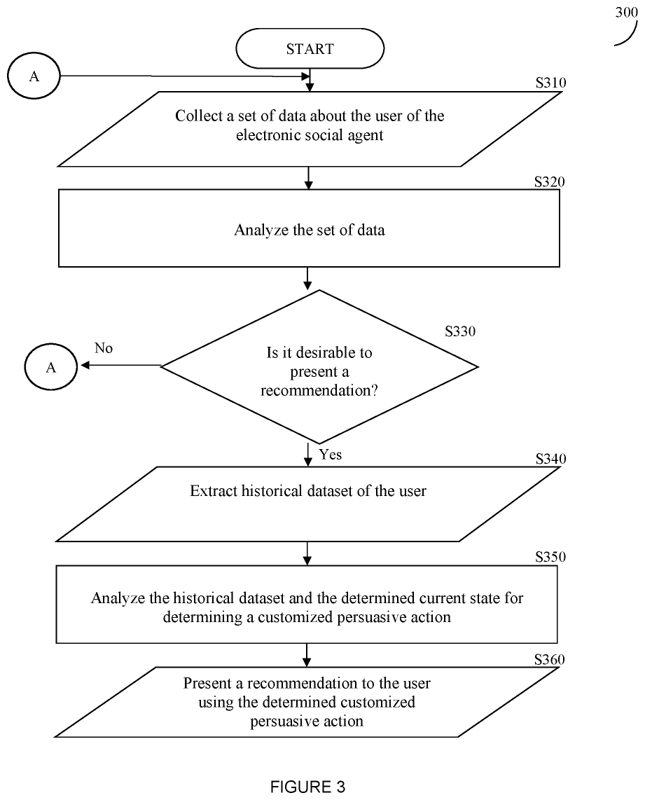

FIG. 3 shows an example flowchart 300 of a method for providing a recommendation by a digital assistant using a persuasive action according to an embodiment. The method described herein may be executed by the controller 200 that is further described herein above with respect to FIG. 2. The controller 200 is integrated in an I/O device operating the digital assistant 120.

At S310, a dataset about a user of the I/O device is collected. The dataset may be collected using one or more sensors, e.g., the sensors 140, from the Internet, from the user's calendar, and the like. Data as may be included in the dataset, which is collected using one or more sensors, such as the sensors 140, may include, without limitation, images, video, audio signals, and the like. Further, such data may be collected in real-time or near-real-time with respect to the first user. In addition, the first dataset may include, without limitation, data related to the environment near the first user such as, for example and without limitation, temperature, traffic conditions, and the like. In an embodiment, the dataset may further include historical data pertaining to the first user, data from one or more web sources, and the like.

At S320, the collected dataset is analyzed to determine the current state of a user. The analysis may be performed by an application of at least one algorithm, such as a machine learning algorithm, which is adapted to determine at least a current state of a user. In an embodiment, the collected dataset is input into a machine learning model that is trained to provide a current state of the user. Such model may be adapted to determine a current state with respect to the environment near the user (e.g., in a predetermined proximity to the user) based on at least a portion of the collected dataset.

The current state may reflect the state of the user and the state of the environment near the user in real-time, or near-real-time. The current state may indicate whether, for example, the user is sleeping, reading, stressed, angry, and so on. The current state may further indicate the current time, the weather, the number of people in the room, the identities of one or more people, or the like. In other configurations, the collected dataset may be analyzed using, for example and without limitations, one or more computer vision techniques, audio signal processing techniques, unsupervised machine learning techniques, and the like.

At S330, it is checked whether it is desirable to present a recommendation to the user based on at least the current state and if so, execution continues with S350; otherwise, execution returns with S310. In an embodiment, S330 further includes determination of a specific recommendation to be presented to the user based on the analyzed dataset and the determined current state. The recommendation would be for the user to perform a certain activity at the present moment, e.g., read a book, mediate, and the like.

At S340, an historical dataset including information on past events, routine, behavior, and the like of the user is obtained. The historical dataset may be indicative to an effective persuasive action for persuading the user to accept the first recommendation. The historical dataset may be obtained from information previously collected and stored in the database. Collectively or alternatively, the historical dataset may be extract from the dataset collected at S310.

At S350, the historical dataset and the determined current state are analyzed. The result of the analysis facilitates the determination of a customized persuasive action to be used for persuading the user to accept the recommendation determined by digital assistant. A customized persuasive action is a convincing method having the highest probability to cause a specific user to accept a specific recommendation of the digital assistant.

In an example embodiment, a customized persuasive action may be determined by learning from user behavior using reinforcement learning techniques. The analysis may be performed by an application of as a machine learning algorithm, which is adapted to determine customized persuasive action. In an embodiment, the historical dataset and the current state are input into a machine learning model that is trained to provide customized persuasive action. Such a model may be further adapted to determine for each optional action a score indicative of the probability that the user would accept the rejection. In such an embodiment, an action with the highest score is selected.

At S360, the recommendation is presented to the user while implementing the determined customized persuasive action. Presenting the first recommendation using the customized persuasive action may be performed by resources (e.g., the resources 150) of the I/O device. For example, if the recommendation to the user is to perform meditation for 10 minutes, and the determined customized persuasive action is an authority-based persuasive action. The I/O device may sound a message “What do Bill Gates, Michael Jordan and Clint Eastwood have in common? They all practice meditation. How about we do a short mindfulness exercise?”.

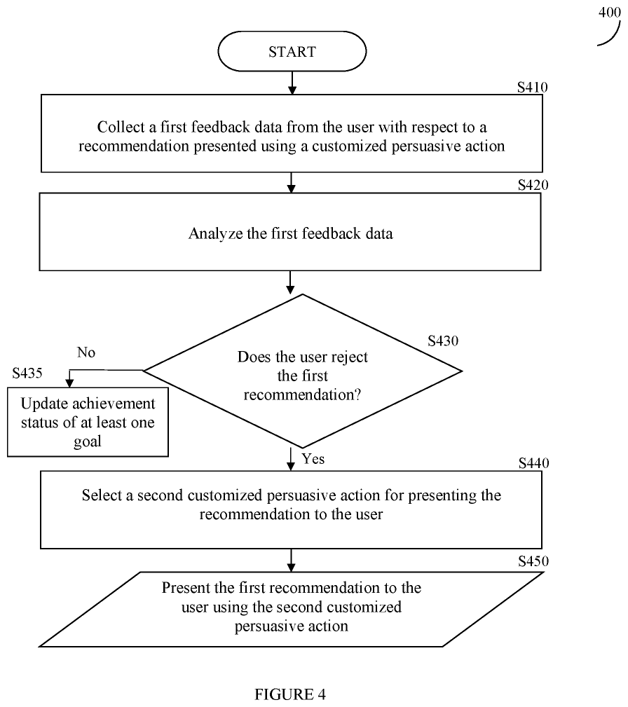

It should be noted that the user's feedback to the recommendation and the customized persuasive action are monitored. This is performed to build an accurate model that can be used for training and to further suggest new recommendations and/or persuasive actions to this user. The method for monitoring the user's feedback is further discussed in FIG. 4.

FIG. 4 shows an example flowchart 400 for improving the recommendation and persuasive action by providing an alternate recommendation and persuasive action to perform the recommendation by the user. The method described herein may be executed by the controller 200 that is further described herein above with respect to FIG. 2. The controller 200 is integrated in I/O device operating the digital assistant 120.

At S410, feedback data is collected from the user with respect to the recommendation presented using a customized persuasive action. The currently presented recommendation and persuasive action are selected above. The feedback data may include real-time data that may be collected from sensors connected in or to the I/O device (e.g., the sensors 140). The feedback data refers to the user's reaction to the recommendation presented using a customized persuasive action.

At S420, the collected feedback data is analyzed to determine if the user has accepted or rejected the action. The analysis of the first feedback data may be achieved using one or more computer vision techniques, audio signal processing techniques, machine learning techniques, and the like. For example, if the recommendation for performing meditation introduced the message, “What do Bill Gates, Michael Jordan and Clint Eastwood have in common? They all practice meditation. How about we do a short mindfulness exercise?” and the user responded “Yes, let's do it,” the user's voice may be analyzed using a speech recognition technique to determine that the user accepted the message.

At S430, it is checked, based on the results of the analysis, whether the user has rejected the presented recommendation. If so, execution continues with S440; otherwise, execution continues with S435.

At S435, upon determination that the user accepts the recommendation and performs the recommended action, an achievement status of at least one predetermined goal of the user may be updated respectively. The predetermined goals of the user may be a series of goals related to the user's physical health, mental health, social relationships, and so on. The user's goal achievement status may indicate if all the goals of the user were achieved (e.g., for today) already and if not, what the achievement level of each one of the goals is. For example, each goal may have a score from “0” to “10” when “0” is the lowest value and “10” is the highest value. A “10” value means that the goal was achieved and a “0” to “9” value means that the user still needs to accomplish certain activities, missions, and so on, in order to achieve a certain goal.

At S440, upon determination that the user has rejected the presented recommendation, a new customized persuasive action is determined. This can be achieved based on the analysis of a historical dataset of the user that was previously collected and a current state that is determined in real-time, as well as the feedback data. In an optional embodiment, the alternative persuasive action is an action that was previously determined as having the second-highest score from the actions determined at S350.

At S450, the recommendation is now presented to using the new customized persuasive action determined at S440. Presentation of a recommendation may be performed using resources of the I/O device as further discussed herein above with respect to FIG. 2 and FIG. 3.

The various disclosed embodiments may be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the disclosure and the concepts contributed by the inventor to furthering the art and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A person skilled-in-the-art will readily note that other embodiments of the disclosure may be achieved without departing from the scope of the disclosed disclosure. All such embodiments are included herein. The scope of the disclosure should be limited solely by the claims thereto.

What is claimed is:

1. A method for providing a recommendation by a digital assistant using a persuasive action, comprising:
determining a recommendation for a user of the digital assistant to perform a certain activity, wherein the recommendation is determined based on a current state of the user;
analyzing a historical dataset related to the user to compile a persuasive action, wherein the persuasive action is customized based on at least one convincing method and based on the analysis of the historical dataset and the current state of the user; and
presenting the determined recommendation by applying the persuasive action, wherein the recommendation is presented by means of an input/output (I/O) device executing the digital assistant, wherein the persuasive action is a convincing method having the highest probability to cause the user to accept the recommendation of the digital assistant.

2. The method of claim 1, further comprising:
monitoring a feedback of the user to the presented recommendation;
determining an alternate recommendation when the user rejects the presented recommendation;
compiling an alternate persuasive action based on analysis of the historical dataset; and
presenting the determined alternate recommendation by applying the alternate persuasive action.

3. The method of claim 1, wherein determining the recommendation further comprises:
collecting a dataset related to the user; and
applying a machine learning model trained to determine the current state based on the collected dataset, wherein the current state is state of a user and the state of the environment near the user in real-time, or near real-time.

4. The method of claim 3, wherein collected dataset includes: real-time data related to a user through at least one sensor connected to the I/O device; and historical data related to past activity of the user through sources external to the I/O device.

5. The method of claim 1, wherein the convincing method of the persuasive action is anyone of: authority-based persuasive, consensus-based persuasive, reward-based persuasive, reciprocity-based persuasive, commitment-based persuasive, and scarcity-based persuasive action.

6. The method of claim 5, further comprising:
compiling the persuasive action to communicate at least one preconfigured message.

7. The method of claim 5, further comprising:
computing a probability for each convincing method based in part of the current state of the user; and
using the convincing method with the highest probability to compile the persuasive action.

8. A non-transitory computer readable medium having stored thereon instructions for causing a processing circuitry to execute a process, the process comprising:
determining a recommendation for a user of the digital assistant to perform a certain activity, wherein the recommendation is determined based on a current state of the user;
analyzing a historical dataset related to the user to compile a persuasive action, wherein the persuasive action is customized based on at least one convincing method and based on the analysis of the historical dataset and the current state of the user;
presenting the determined recommendation by applying the persuasive action, wherein the recommendation is presented by means of an input/output (I/O) device executing the digital assistant, wherein the persuasive action is a convincing method having the highest probability to cause the user to accept the recommendation of the digital assistant.

9. A system for providing a recommendation by a digital assistant using a persuasive action, comprising:
a processing circuitry; and
a memory, the memory containing instructions that, when executed by the processing circuitry, configure the system to:
determine a recommendation for a user of the digital assistant to perform a certain activity, wherein the recommendation is determined based on a current state of the user;
analyze a historical dataset related to the user to compile a persuasive action, wherein the persuasive action is customized based on at least one convincing method and based on the analysis of the historical dataset and the current state of the user; and
present the determined recommendation by applying the persuasive action, wherein the recommendation is presented by means of an input/output (I/O) device executing the digital assistant, wherein the persuasive action is a convincing method having the highest probability to cause the user to accept the recommendation of the digital assistant.

10. The system of claim 9, wherein the system is further configured to:
monitor feedback of the user to the presented recommendation;
determine an alternate recommendation when the user rejects the presented recommendation;
compile an alternate persuasive action based on analysis of the historical dataset; and
present the determined alternate recommendation by applying the alternate persuasive action.

11. The system of claim 9, wherein the system is further configured to:
collect a dataset related to the user; and
apply a machine learning model trained to determine the current state based on the collected dataset, wherein the current state is state of a user and the state of the environment near the user in real-time, or near real-time.

12. The system of claim 11, wherein the collected dataset includes: data related to a user through at least one sensor connected to the I/O device; and collecting historical data related to past activity of the user through sources external to the I/O device.

13. The system of claim 9, wherein the convincing method of the persuasive action is anyone of: authority-based persuasive, consensus-based persuasive, reward-based persuasive, reciprocity-based persuasive, commitment-based persuasive, and scarcity-based persuasive action.

14. The system of claim 9, wherein the system is further configured to:
compile the persuasive action to communicate at least one preconfigured message.

15. The system of claim 9, wherein the system is further configured to:
compute a probability for each convincing method based in part of the current state of the user; and
use the convincing method with the highest probability to compile the persuasive action.
